(19) United States
(12) Patent Application Publication
(10) Pub. No.: US 2007/0138150 A1
(43) Pub. Date: Jun. 21, 2007

(54) Hand-held laser welding wand position determination system and method

(75) Inventor: Devlin M. Gualtieri, Ledgewood, NJ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/313,880

(22) Filed: Dec. 20, 2005

(51) Int. Cl. B23K 26/20

(52) U.S. Cl. 219/121.63; 219/121.83

(57) ABSTRACT

A system, and the method implemented thereby, determines the position of a hand-held laser welding wand relative to a surface and, based on the determined position, selectively inhibits laser emission from a laser source. The system includes a plurality of wave emitters, a plurality of receivers, a phase detector, and a position determination circuit. The wave emitters emit a wave including at least a predetermined frequency, the wave receivers receive the emitted waves and supply representative receiver signals. The phase detector determines the phase differences between a reference signal and each of the receiver signals, and the position determination circuit determines the position of the laser welding wand relative to the surface based on the determined phase differences.

### TECHNICAL FIELD

The present invention relates to laser welding and, more particularly, to a system and method for determining the position of a hand-held laser welding wand and selectively inhibiting laser emission from the welding wand based on the determined position.

### BACKGROUND

Many components in a jet engine are designed and manufactured to withstand relatively high temperatures. Included among these components are the turbine blades, vanes, and nozzles that make up the turbine engine section of the jet engine. In many instances, various types of welding processes are used during the manufacture of the components, and to repair the components following a period of usage. In addition, other non-aerospace applications such as, for example, industrial and commercial tooling and die maintenance may also benefit from the laser welding repair process. Moreover, various types of welding technologies and techniques may be used to implement these various welding processes. However, one particular type of welding technology that has found increased usage in recent years is laser welding technology.

Laser welding technology uses a high power laser to manufacture parts, components, subassemblies, and assemblies, and to repair or dimensionally restore worn or damaged parts, components, subassemblies, and assemblies. In general, when a laser welding process is employed, laser light of sufficient intensity to form a melt pool is directed onto the surface of a metal work piece, while a filler material, such as powder, wire, or rod, is introduced into the melt pool. Until recently, such laser welding processes have been implemented using automated laser welding machines. These machines are relatively large, and are configured to run along one or more preprogrammed paths.

Although programmable laser welding machines, such as that described above, are generally reliable, these machines do suffer certain drawbacks. For example, a user may not be able to manipulate the laser light or work piece, as may be needed, during the welding process. This can be problematic for weld processes that involve the repair or manufacture of parts having extensive curvature and/or irregular or random distributed defect areas. Thus, in order to repair or manufacture parts of this type, the Assignee of the present application developed a portable, hand-held laser welding wand. Among other things, this hand-held laser welding wand allows independent and manual manipulation of the laser light, the filler material, and/or the work piece during the welding process. An exemplary embodiment of the hand-held laser welding wand is disclosed in U.S. Pat. No. 6,593,540, which is entitled “Hand Held Powder-Fed Laser Fusion Welding Torch,” and the entirety of which is hereby incorporated by reference.

The hand-held laser welding wand, such as the one described above, provides the capability to perform manual 3-D adaptive laser welding on components. However, because it does use a laser beam, it does present certain drawbacks. Namely, the laser beam can propagate relatively long distances and, depending on the energy of the laser beam, can have potentially deleterious effects on the human eye, can potentially cause burns, and can have potentially deleterious effects on the work surface or surrounding materials and devices, if unintentionally pointed in an unintended direction. Hence, the hand-held laser welding wand includes a safety interlock that inhibits laser emission if the wand is not properly positioned. The safety interlock is a proximity switch that is coupled to the wand and spring biased to an open position. As the wand is brought into proximity with a surface, the proximity switch engage the surface and, against the force of the bias spring, will close and allow laser emission from the laser.

Although the proximity switch described above is generally robust, reliable, and safe, it does have certain drawbacks. Namely, it relies on physical contact with the work surface, it does not allow the proximity settings to be set dynamically, and it can be overridden manually.

Hence, there is a need for a system and method for determining the position of the hand-held laser welding wand, and selectively inhibiting laser emission therefrom, that does not rely on physical contact, allows the proximity settings to be dynamically set, and cannot be readily overridden manually. The present invention addresses one or more of these needs.

### BRIEF SUMMARY

The present invention provides a system and method for determining the position of the hand-held laser welding wand and, based on the determined position, selectively inhibiting laser emission therefrom. In one embodiment, and by way of example only, a system for determining a position of a hand-held laser welding wand relative to a surface includes a plurality of wave emitters, a plurality of wave receivers, a phase detector, and a position determination circuit. Each wave emitter is adapted to be disposed at least adjacent the surface and is coupled to receive a signal that includes at least a predetermined frequency and is operable, upon receipt thereof, to emit a wave that includes at least the predetermined frequency. Each wave receiver is adapted to receive the emitted waves and is operable, upon receipt thereof, to supply receiver signals representative of the emitted waves. The phase detector is coupled to receive each of the receiver signals and a reference signal of the predetermined frequency. The phase detector is configured to determine phase differences between the reference signal and each of the receiver signals and to supply phase difference signals representative thereof. The position determination circuit is coupled to receive the phase difference signals and is operable, upon receipt thereof, to determine the position of the laser welding wand relative to the surface.

In another exemplary embodiment, a method of determining a position of a hand-held laser welding wand relative to a surface includes transmitting a wave from a plurality of positions on the surface, each transmitted wave including at least a predetermined frequency. Each of the transmitted waves is received at a plurality of locations on the hand-held laser welding wand, and phase shifts between the transmitted waves and the received waves at each of the plurality of locations are determined. The position of the laser welding wand relative to the surface is determined based on the determined phase shifts.

Other independent features and advantages of the preferred position determination system and method will become apparent from the following detailed description, taken in conjunction with the accompanying drawings which illustrate, by way of example, the principles of the invention.

### BRIEF DESCRIPTION OF THE DRAWINGS

FIG. 1 is a side view of an exemplary hand-held laser welding wand;

FIG. 2 is a perspective exploded view of the hand-held laser welding wand of FIG. 1;

FIG. 3 is a partial cut-away perspective views of the hand-held laser welding wand shown in FIGS. 1 and 2;

FIG. 4 is a simplified schematic representation of the hand-held laser welding wand of FIG. 1 coupled to a laser source and an exemplary position determination system of the present invention;

FIG. 5 schematically depicts how distance can be determined from phase shifts between transmitted and a received waves;

FIG. 6 is a functional block diagram of a particular embodiment of the position determination system depicted in FIG. 4; and

FIG. 7 is a functional block diagram of an exemplary alternative embodiment of the position determination system.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

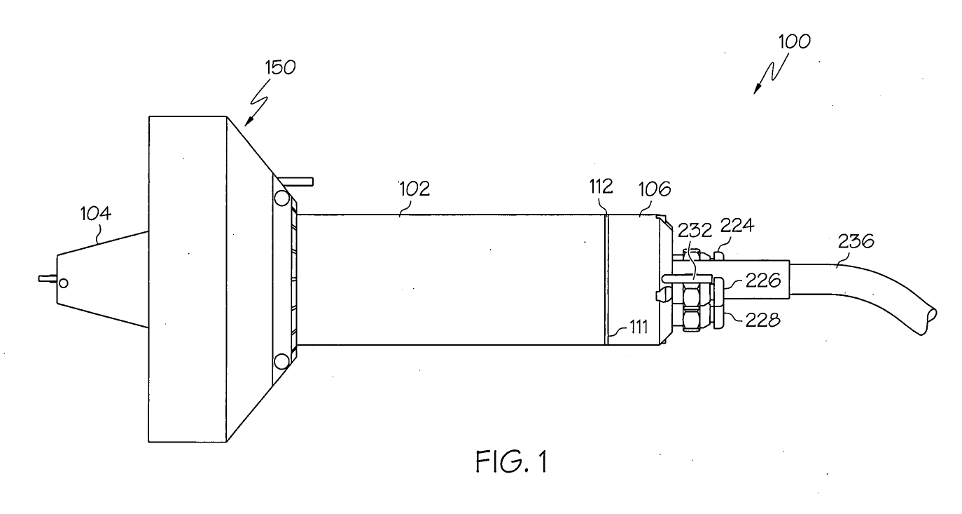

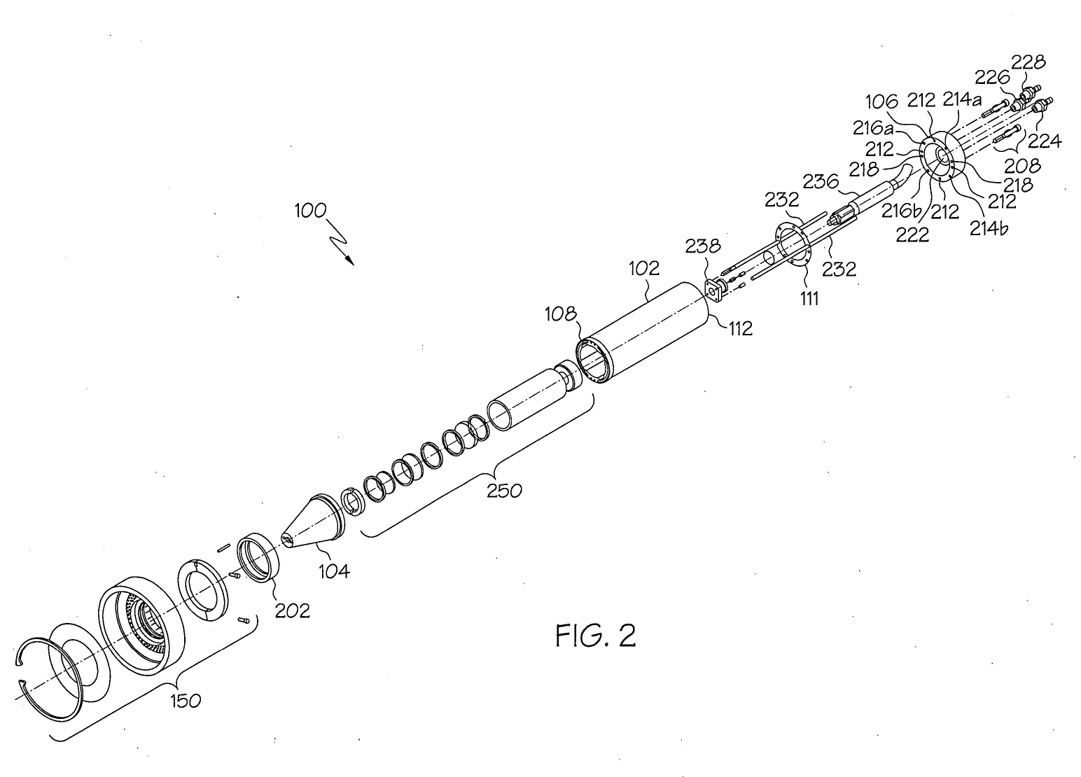

Turning now to the description, and with reference first to FIGS. 1-3, an exemplary hand-held laser welding wand 100 is shown, and includes a main body 102, a nozzle 104, and an end cap 106. The main body 102, which is preferably configured as a hollow tube, includes a first end 108 (see FIG. 2), a second end 112, and a plurality of orifices and flow passages that extend between the main body first and second ends 108, 112. The orifices and flow passages are used to direct various fluids and other media through the main body 102. Included among these media are coolant, such as water, inert gas, such as Argon, and filler materials, such as powder, wire, or liquid. These orifices and flow passages are in fluid communication with orifices and flow passages in the nozzle 104, in the end cap 106, or both. A description of the specific configuration of each of the orifices and flow paths in the main body 102 is not needed. Thus, at least the coolant and gas orifices and flow passages in the main body 102 will not be further described. The main body filler media orifices and flow passages will be mentioned further below merely for completeness of description.

The nozzle 104 is coupled to the main body first end 108 via a threaded nozzle retainer ring 202. More specifically, in the depicted embodiment the main body 102 has a plurality of threads formed on its outer surface adjacent the main body first end 108. Similarly, the nozzle retainer ring 202 has a plurality of threads formed on its inner surface that mate with the main body threads. Thus, the nozzle 104 is coupled to the main body 102 by abutting the nozzle 104 against the main body first end 108, sliding the nozzle retainer ring 202 over the nozzle 104, and threading the nozzle retainer ring 202 onto the main body 102. It will be appreciated that the nozzle 104 could be coupled to the main body first end 108 in a different manner. For example, the nozzle 104 and main body 102 could be configured so that the nozzle 104 is threaded directly onto the main body first end 108.

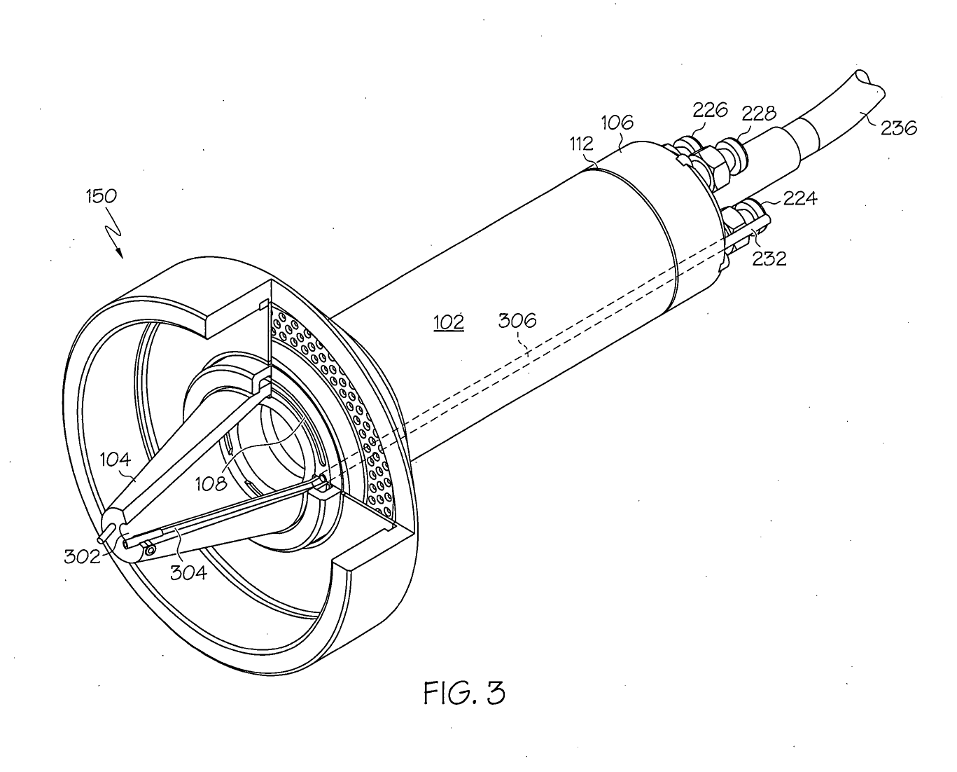

With reference to FIG. 3, it is seen that the nozzle 104 includes an aperture 302 that extends through the nozzle 104. When the nozzle 104 is coupled to the main body 102, the nozzle aperture 302 is in fluid communication with the inside of the hollow main body 102. It is through this aperture 302 that laser light and gas pass during laser welding operations. The nozzle 104 additionally includes a plurality of filler media flow passages 304. The nozzle filler media flow passages 304 pass through the nozzle 104 and are in fluid communication with filler media delivery flow passages 306 that extend through the main body 102. The filler media delivery flow passages 304, 306 are used to deliver a filler media to a work piece (not shown).

The end cap 106 is coupled to the main body second end 112 via a gasket 111 and a plurality of end cap fasteners 208. In particular, the end cap fasteners 208 extend, one each, through a plurality of end cap fastener openings 212 (see FIG. 2) formed through the end cap 106, and into the main body second end 110. In addition to the end cap fastener openings 212, the end cap 106 also includes two coolant passages 214, 216, a gas supply passage (not shown), a plurality of filler media flow passages 218, and a cable opening 222. The two coolant passages include a coolant supply passage 214 and a coolant return passage 216. The coolant supply passage 214, which splits within the end cap 106 into two supply passages 214a, 214b, directs coolant, such as water, into appropriate coolant flow passages formed in the main body 102. The coolant return passage 216, which also splits within the end cap 106 into two return passages 216a, 216b, receives coolant returned from appropriate coolant flow passages formed in the main body 102. The non-illustrated gas supply passage directs gas into the main body 102.

The end cap filler media flow passages 218 are in fluid communication with the nozzle filler media flow passages 304 via the main body filler media flow passages 306. The end cap filler media passages 218 may be coupled to receive any one of numerous types of filler media including, but not limited to, powder filler and wire filler. The filler media may be fed into the end cap filler media flow passages 218 manually, or the filler media may be fed automatically from a filler media feed assembly (not shown). In the depicted embodiment, a plurality of filler media liner tubes 232 is provided. These filler media liner tubes 232 may be inserted, one each, through one of the end cap filler flow media passages 218, and into the main body filler media flow passages 306. The filler media liner tubes 232 further guide the filler media into and through the main body 102, and into the nozzle filler media flow passages 304. The filler media liner tubes 232 also protect the filler media flow passages against any erosion that could result from filler media flow through the flow passages. Although use of the filler media liner tubes 232 is preferred, it will be appreciated that the wand 100 could be used without the filler media liner tubes 232.

The cable opening 222 in the end cap 106 is adapted to receive an optical cable 236. When the optical cable 236 is inserted into the cable opening 222, it extends through the end cap 106 and is coupled to a cable receptacle 238 mounted within the main body 102. The optical cable 236 is used to transmit laser light from a laser source (not shown) into the main body 102. An optics assembly 250 is mounted within the main body 102 and is used to appropriately collimate and focus the laser light transmitted through the optical cable 236 and receptacle 238, such that the laser light passes through the nozzle aperture 302 and is focused on a point in front of the nozzle aperture 302.

The laser light transmitted through the nozzle aperture 302 is used to conduct various types of welding processes on various types, shapes, and configurations of work pieces. In many instances, the work pieces are formed, either in whole or in part, of various materials that require an inert atmosphere at least near the weld pool during welding operations. Thus, the hand-held laser welding wand 100 additionally includes a gas lens assembly 150, which is mounted on the wand main body 102 and surrounds a portion of the nozzle 104. The gas lens assembly 150 is adapted to receive a flow of inert gas from the non-illustrated gas source and is configured, upon receipt upon receipt of the gas, to develop an inert gas atmosphere around the weld pool.

As was just noted, the optical cable 236 transmits laser light from a laser source for use by the wand 100. In addition, barbed fittings 224, 226, 228 are coupled to the coolant supply passage 214, the coolant return passage 216, and the non-illustrated gas supply passage, respectively, in the end cap 106. These barbed fittings 224, 226, 228 are used to couple the respective openings to hoses or other flexible conduits that are in fluid communication with a coolant source or a gas source, as may be appropriate. It will be appreciated that other types of fittings, such as compression or threaded fittings, may be substituted for one or more of the barbed fittings 224, 226, 228, as needed or desired, based on the particular types of hoses or conduits used. Moreover, the filler media supply tubes 232 are preferably in fluid communication with one or more filler media sources via one or more filler media conduits.

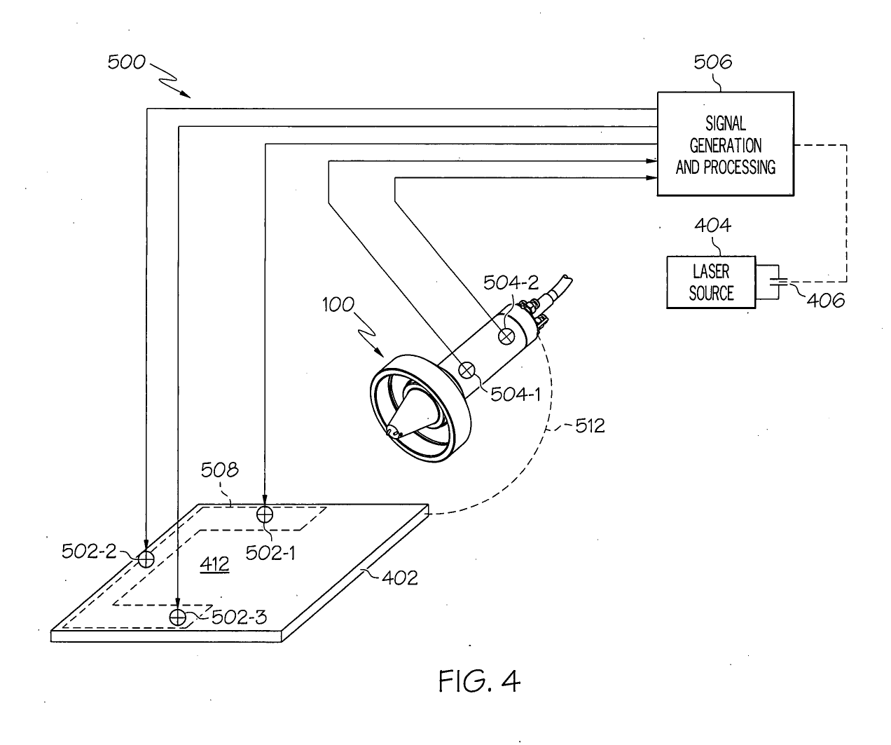

With reference now to FIG. 4, the hand-held laser welding wand 100 is schematically depicted being disposed near a workpiece 402, and coupled to a laser source 404 and a position determination system 500. The laser source 404, if enabled to do so, is configured to emit laser light into the welding wand 100, via the optical cable 236. As FIG. 4 also shows, the laser source 404 is selectively enabled and disabled by the position determination system 500. More specifically, and as will be described in more detail below, the position determination system 500 determines the position of the hand-held laser welding wand 100 relative to the work piece 402 and, if the position falls outside of predetermined limits, disables the laser source 404 by, for example, opening an interlock contact 406.

The position determination system 500 includes a plurality of wave emitters 502, a plurality of wave receivers 504, and signal generation and processing circuitry 506. The wave emitters 502 are each adapted to be disposed adjacent to the work piece 402. This can be accomplished using any one of numerous techniques. For example, the wave emitters 502 can be configured to temporarily mount directly to the work piece 402 or, more preferably, are mounted to a common frame 508 (shown in phantom in FIG. 4) that is temporarily coupled to the work piece 402 and surrounds, or at least partially surrounds, a desired work area 412 on the work piece 402.

In the depicted embodiment, the system 500 includes three wave emitters 502 (502-1, 502-2, 502-3). It will be appreciated, however, that this is merely exemplary of a particular preferred embodiment, and that other numbers of wave emitters 502 could be used. It will additionally be appreciated that the wave emitters 502 may be implemented using any one of numerous types of devices that, upon receipt of an appropriate signal, will emit a wave. For example, the wave emitters 502 could be implemented as any one of numerous radio frequency (RF) wave emitters, such as RF antennae, or as any one of numerous optical wave emitters, or as any one of numerous acoustic wave emitters, such as loudspeakers.

No matter how the wave emitters 502 are specifically implemented, each is coupled to receive a signal from the signal generation and processing circuitry 506 and is operable, in response to the signal, to emit a wave. As will be described in more detail further below, the emitted wave may include one or more frequencies, but will include at least a predetermined frequency. The particular type of wave that the wave emitters 502 emit will vary, depending on the particular type of wave emitter 502 that is used. For example, when the emitters 502 are implemented as RF wave emitters, the emitted waves will be RF waves, when the emitters 502 are implemented as optical wave emitters, the emitted waves will be light waves, and when the emitters 502 are implemented as acoustic wave emitters, the emitted waves will be sound waves.

The waves emitted by the wave emitters 502 are received by the wave receivers 504. As FIG. 4 shows, each wave receiver 504 is coupled to the laser welding wand 100. It will be appreciated that the wave receivers 504 may be coupled to the laser welding wand 100 in either a permanent or releasable manner, but are preferably coupled thereto in a releasable manner. Moreover, and as FIG. 4 clearly illustrates, the wave receivers 504 are preferably coupled to the laser welding wand 100 at different locations. As will be explained further below, this allows a more accurate determination of the position of the laser welding wand 100 relative to the work piece 402. As used herein, position includes both the location of the laser welding wand 100 relative to the work piece 402, and the angle of the laser welding wand 100 relative to the work piece 402.

As with the wave emitters 502, the number of wave receivers 502 may vary. Preferably, however, the system 500 is implemented with at least two wave receivers 502 (502-1, 502-2). Moreover, the wave receivers 502 may be implemented as any one of numerous types of devices that, upon receipt of a wave emitted by one of the wave emitters 504, will supply a receiver signal representative of the emitted wave. It will be appreciated that the particular type of wave receivers 504 that are used will depend upon the particular type of wave emitters 502 that are used. For example, if RF wave emitters 502 are used, the wave receivers 504 will be implemented as RF wave receivers, such as RF antennae. Similarly, if optical wave emitters 502 or acoustic wave emitters 502 are used, the wave receivers will be implemented as optical wave receivers 504, such as photo-detectors, or acoustic wave receivers 504, such as microphones. No matter how the wave receivers 504 are specifically implemented, each is configured, upon receipt of an emitted wave, to supply a receiver signal representative of the emitted wave to the signal generation and processing circuitry 506.

The signal generation and processing circuitry 506, as described above, is configured to supply the signals to each of the wave emitters 502 and to receive the receiver signals from each of the wave receivers 504. The signal generation and processing circuitry 506 is further configured to determine phase shifts between the waves emitted by the wave emitters 502 and the waves received by the wave receivers 504 and, based on the determined phase shifts, to determine the position of the laser welding wand relative to the work piece 402. The signal generation and processing circuitry 506 is also configured to disable the laser source 404 if the position of the laser welding wand 100 is determined to be outside of one or more predetermined position limits. Various embodiments of the signal generation and processing circuitry 506 will be described in more detail further below. Before doing so, however, a brief description of the general methodology that the position determination system 500 implements will first be provided.

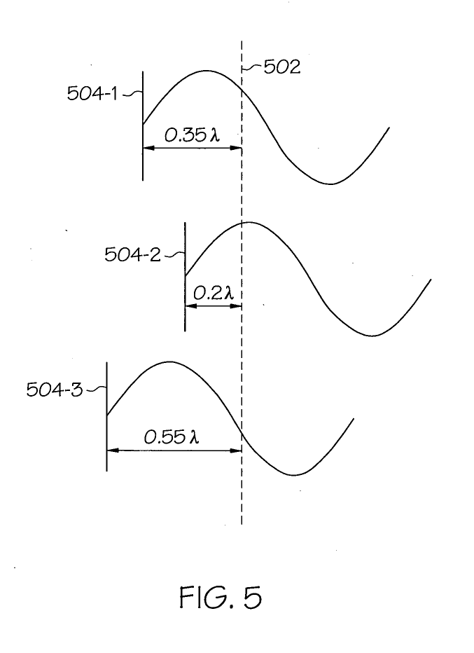

When a receiver, such as one of the wave receivers 504 described above, is within a wavelength of a wave emitted from a wave emitter, such as one of the wave emitters described above 502, the distance (D) of the wave receiver from the wave transmitter can be determined according to the following:

$$D = \frac{λ θ}{360} ,$$

where λ is the wavelength of the wave, and θ is the relative phase angle (in degrees) between the emitted and received waves. An implementation of this equation is depicted in FIG. 5, which depicts how the distance between a wave receiver 504 and three wave emitters 502-1, 502-2, 502-3 can be determined by measuring the phase shifts between the emitted and received waves, when the wave receiver 504 is within one wavelength of each of the wave emitters 502.

It will be appreciated that the above equation is valid for, and the system 500 can be configured to accommodate, any distance between wave emitters 502 and receivers 504, if the absolute (rather than relative) phase angle is determined. However, the position determination system 500 is preferably implemented such that the distance between the wave emitters 502 and wave receivers 504 is limited to no more than one wavelength. To do so, the system 500 preferably includes a tether 512, which is shown in phantom in FIG. 4, that is coupled between the laser welding wand 100 and the structure to which the wave emitters 502 are coupled. It will be appreciated that the tether 512 can also be used to house the electrical cabling between the laser welding wand 100, the wave emitters 502, the wave receivers 504, the signal generation and processing circuitry 506, and various other support systems, such as the laser source 402, if so desired.

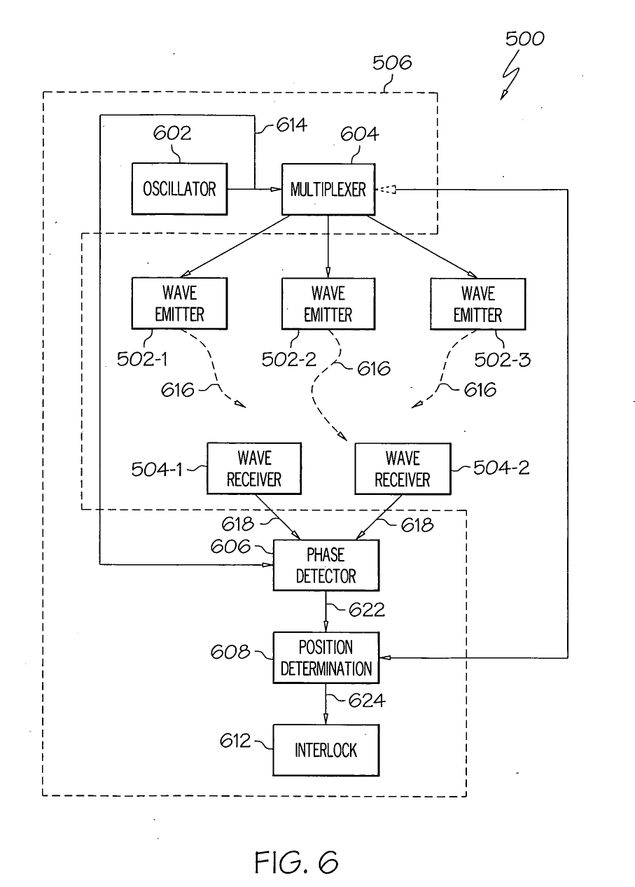

Turning now to FIG. 6, a functional block diagram of the position determination system 500, which more clearly depicts a particular embodiment of the signal generation and processing system 506, is provided and will be described in more detail. In the depicted embodiment, the wave emitters 502 and wave receivers 504 are each depicted, and the signal generation and processing system 506 is shown to include an oscillator 602, a multiplexer 604, a phase detector 606, a position determination circuit 608, and an interlock 612. Before describing each of these in more detail, it will be appreciated that although these circuits are depicted separately, one or more or all of the blocks could be implemented as part of a single circuit device, such as a processor. Moreover, some or all of the circuits may be implemented wholly or partially in hardware, software, firmware, or various combinations thereof.

Turning now to the description of the circuit 506, the oscillator 602 is configured to generate a reference signal 614 of a predetermined frequency for emission by each of the wave emitters 502. The oscillator 602 may be implemented as any one of numerous types of oscillator circuits now known or developed in the future, and is coupled to supply the reference signal to the multiplexer 604 and the phase detector 606. It will additionally be appreciated that the oscillator 602 may be configured to generate the reference signal 614 at any one of numerous predetermined frequencies, which may vary depending, for example, on whether the system 500 is being implemented as an RF system, an optical system, or an acoustical system. A more detailed discussion of particular preferred operating frequencies of the position determination system 500 is provided further below.

The reference signal 614 generated by the oscillator 602 is, as was just noted, supplied to both the multiplexer 604 and the phase detector 606. The multiplexer 604, which may be implemented using any one of numerous known multiplexer circuit devices, is configured to selectively supply the reference signal 614 to each of the wave emitters 502. The multiplexer 604 is also in operable communication with the position determination circuit 608, and is configured to supply a signal to the position determination circuit 608 representative of which wave emitter 502 is being supplied with the reference signal. Alternatively, as is depicted in phantom in FIG. 6, the position determination circuit 608 could supply a command signal to the multiplexer 604 that controls which wave emitter 502 the multiplexer 604 supplies the reference signal to. As previously described, the wave emitters 502, upon receipt of the reference signal 614, are each operable to emit a wave 616 at the predetermined frequency. It is noted that the system 500 is preferably configured so that the wave emitters 502 and wave receivers 502 operate on the same frequency. Thus, the multiplexer 604 is preferably controlled so that the wave emitters 504 cycle sequentially so as to not interfere with each other.

The wave receivers 504, as was also previously described, are each configured to receive the emitted waves 616 and, upon receipt thereof, supply a receiver signal 618 to the phase detector 606. The phase detector 606 receives not only the receiver signals 618 from each of the wave receivers 504, but also the reference signal 614 from the oscillator 602. The phase detector 606, which may be implemented as any one of numerous known phase detector circuit devices, is configured to determine a phase difference between the reference signal 614 and each of the receiver signals 618, and to supply phase difference signals 622 representative of the determined phase differences to the position determination circuit 608.

The position determination circuit 608 receives the phase difference signals 622 from the phase detector 606. In response to these signals 622, the position determination circuit 608 determines the location of each of the wave receivers 504 relative to each of the wave emitters 502, and from this may thus determine the position of laser welding wand 100 relative to the work piece 402. More specifically, the position determination circuit 608, preferably implementing the above described equation, calculates the location of the wave receivers 504 relative to the work piece 402 from the positions of the wave emitters 502 and the relative phases. The position determination circuit 608 then calculates the angle of orientation of the laser welding wand 100 from the calculated wave receiver 504 positions. From these data, the position (location and angle) of the laser welding wand 100 relative to the work piece 402 is determined.

In addition to determining the relative position of the laser welding wand 100, the position determination circuit 608 compares the determined relative position to one or more predetermined position limits. If the position determination circuit 608 determines that the laser welding wand 100 is outside of one or more of these predetermined position limits, it generates and supplies an interlock signal 624 to the interlock 612. The interlock 612, in response to the interlock signal 624, selectively enables or disables the laser source 404. It will be appreciated that the interlock 612 may implemented as any one of numerous known interlock devices. Moreover, the interlock signal 624 may be generated according to any one of numerous signal paradigms, which may depend, for example, on the particular implementation of the interlock 612. For example, the interlock 612 may be implemented as a relay, or a switch, just to name a few, and the interlock 612 may be configured as an energize-to-open or an energize-to-close device. Thus, while it will be appreciated that the magnitude of the interlock signal 624 will vary based on the comparison of the determined relative position to the one or more predetermined limits, whether the magnitude of the interlock signal 624 increases or decreases when the determined position is outside of one or more of the predetermined limits will depend on the type and configuration of the interlock 612.

As was previously noted, the frequency of the reference signal 614 generated by the oscillator 602 may vary depending on whether the system 500 is being implemented as an RF system, an optical system, or an acoustical system. In particular, if the system 500 is being implemented as an RF system, then the oscillator 602 will preferably be configured to generate the reference signal 614 at a frequency that falls within the designated Industrial-Scientific-Medical (ISM) frequency bands. These frequency bands include various frequencies that range from 6.78±0.15 MHz to 245±1.0 GHz, and include a 915±13 MHz frequency band. The wavelength of a 915 MHz wave is slightly greater than one foot (e.g., about 0.38 meters), which makes this frequency particularly suitable. It will be appreciated that the oscillator 602 could be configured to generate the reference signal 614 at frequencies outside of these frequency bands. If this is done, however, the reference signal should, in accordance with certain regulatory restrictions, be limited in power.

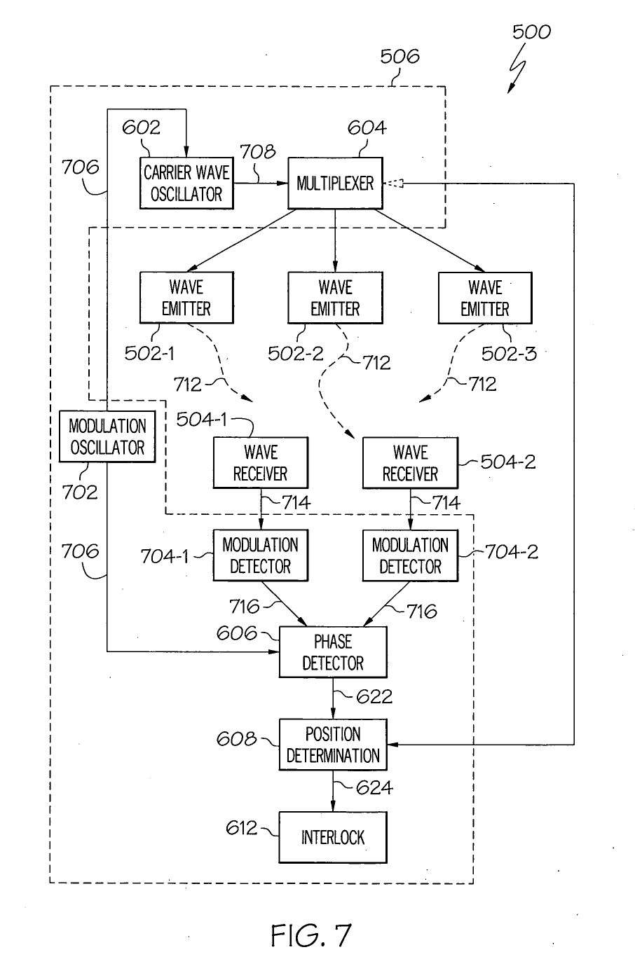

The position determination system 500 could also be implemented according to an alternative embodiment if an operating frequency higher than 915 MHz is needed or desired. In accordance this alternative embodiment, a higher frequency carrier signal is modulated by the lower frequency reference signal. For example, a 5.8 GHz signal can be modulated with a 60 MHz signal, which is the maximum modulation frequency allowed by the ISM bandwidth, and which increases the range of the system 500 to about five meters. Similarly, a 24 GHz signal can be modulated at 125 MHz, which provides a range of greater than two meters. A block diagram of an exemplary alternative embodiment of the position determination system 500 that implements this modulation scheme is depicted in FIG. 7, and with reference thereto will now be described.

The position determination system 500 depicted in FIG. 7 includes each of the elements 602-608 of the previously described embodiment, but additionally includes a modulation oscillator 702 and a plurality of modulation detectors 704 (704-1, 704-2). Because each of the circuit elements 604-608 preferably function generally identical to those of the previous embodiment, a detailed description of these elements 604-608 will not be repeated. One difference, however, is that the oscillator 602, in addition to generating a signal of a predetermined frequency, is configured to modulate the generated signal with a reference signal and supply a modulated signal. Thus, in the embodiment depicted in FIG. 7, the oscillator 602 is labeled as a carrier wave oscillator, and in the subsequent descriptions is described as generating a carrier signal of a predetermined frequency and supplying a modulated carrier signal.

The modulation oscillator 702 is configured to generate a reference signal 706 of a predetermined frequency. The oscillator 702 may be implemented as any one of numerous types of oscillator circuits now known or developed in the future, and is coupled to supply the reference signal 706 to the carrier wave oscillator 602 and the phase detector 606. It will additionally be appreciated that the modulation oscillator 702 may be configured to generate the reference signal 706 at any one of numerous predetermined frequencies that preferably fall within the ISM band.

The carrier wave oscillator 602, as noted above, generates a carrier signal of a predetermined carrier frequency and, upon receipt of the reference signal from the modulation oscillator 702, modulates the carrier signal at the predetermined frequency of the reference signal 706 and supplies the modulated carrier signal 708 to the multiplexer 604. Although the carrier wave oscillator 602 could be configured to implement any one of numerous modulation schemes, it will be appreciated that it preferably implements an amplitude modulation (AM) scheme. No matter the specific modulation scheme that is implemented, the modulated carrier signal 706 will include the predetermined frequency as a component.

The remaining differences between the embodiment of FIGS. 6 and 7 are that the wave emitters 502 emit, and the wave receivers 504 receive, modulated carrier waves 712, the wave receivers 504 each supply a receiver signal 714 representative of the modulated carrier waves 712, and the system 500 includes the plurality of modulation detectors 704. The modulation detectors 704 are each coupled to one of the wave receivers 504 and to the phase detector 606. The modulation detectors 704 receive the receiver signals 714, demodulate the received reference signal from the carrier signal, and supply the demodulated reference signal 716 to the phase detector 606. The phase detector 606, position determination circuit 608, and interlock 612 preferably function identical to the previous embodiment.

From the above, it will be appreciated that the RF frequencies at which the position determination system 500 may operate may potentially be limited. Thus, as was previously noted, the system 500 may be configured to operate in the optical frequency spectrum or the audio frequency spectrum. As was also previously noted, when configured to operate in the optical frequency spectrum, the wave emitters 502 and wave receivers 504 are implemented as optical transmitters and photo-detectors, respectively. It will additionally be appreciated that when the system 500 is configured to operate in the optical frequency spectrum it is preferably, though not necessarily, implemented in accordance with the embodiment of FIG. 7, such that an RF modulation is imposed on the optical transmitters.

If the system 500 is configured to operate in the audio frequency range, the wave emitters 502 and wave receivers 504, as was also previously noted, are preferably implemented as loudspeakers and microphones, respectively. One limitation that may be placed on this particular system is the update time, which may be longer since audio frequencies are much lower than either RF or optical frequencies. It is noted that a 500 Hz tone would provide a range of about two feet.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

I claim:

1. A system for determining a position of a hand-held laser welding wand relative to a surface, comprising:
a plurality of wave emitters adapted to be disposed at least adjacent to the surface, each wave emitter configured to receive a signal that includes at least a predetermined frequency and operable, upon receipt thereof, to emit a wave that includes at least the predetermined frequency;
a plurality of wave receivers, each wave receiver adapted to receive the emitted waves and operable, upon receipt thereof, to supply receiver signals representative of the emitted waves;
a phase detector coupled to receive each of the receiver signals and a reference signal of the predetermined frequency, the phase detector configured to (i) determine phase differences between the reference signal and each of the receiver signals and (ii) supply phase difference signals representative thereof; and
a position determination circuit coupled to receive the phase difference signals and operable, upon receipt thereof, to determine the position of the laser welding wand relative to the surface.

2. The system of claim 1, further comprising:
a modulation oscillator coupled to the phase detector and configured to generate the reference signal of the predetermined frequency; and
a carrier wave oscillator configured to generate a carrier signal of a predetermined carrier frequency, the carrier wave oscillator coupled to receive the reference signal from the modulation oscillator and operable, upon receipt thereof, to supply a modulated carrier signal to each of the wave emitters for emission thereby as the emitted waves, the modulated carrier signal including the predetermined frequency.

3. The system of claim 2, further comprising:
a multiplexer coupled between the carrier wave oscillator and the plurality of wave emitters, the multiplexer configured to selectively supply the modulated carrier signal to each of the wave emitters; and
a plurality of modulation detectors, each modulation detector coupled between one of the wave receivers and the phase detector and configured to demodulate the reference signal from the carrier wave and supply the reference signal to the phase detector.

4. The system of claim 1, further comprising:
a carrier wave oscillator coupled to the phase detector and configured to generate the reference signal; and
a multiplexer coupled between the carrier wave oscillator and the plurality of wave emitters, the multiplexer configured to selectively supply the reference signal to each of the wave emitters for emission thereby as the emitted waves.

5. The system of claim 1, wherein the position determination circuit is further operable to (i) compare the determined position to one or more predetermined position limits and (ii) supply an interlock signal having a magnitude based on the comparison.

6. The system of claim 5, further comprising:
a laser power circuit coupled to receive the interlock signal and operable, in response thereto, to selectively energize or deenergize a laser.

7. The system of claim 1, wherein:
the plurality of wave emitters comprises three wave emitters; and
the plurality of wave receivers comprises two receivers.

8. The system of claim 1, wherein the determined position includes a distance of the laser welding wand from the surface, and an angle of orientation of the laser welding wand relative to the surface.

9. The system of claim 1, wherein:
the emitted waves are radio frequency (RF) waves; and
each of the wave receivers comprises an RF antennae adapted to mount to the hand-held laser welding wand.

10. The system of claim 1, wherein:
the emitted waves are light waves; and
each of the wave receivers comprises a photo-detector adapted to mount to the hand-held laser welding wand.

11. The system of claim 1, wherein:
the transmitted waves are audio waves; and
each of the wave receivers comprises a microphone adapted to mount to the hand-held laser welding wand.

12. A system for determining a position of a hand-held laser welding wand relative to a surface, comprising:
a modulation oscillator operable to generate a modulation signal of a predetermined frequency;
a carrier wave oscillator configured to generate a carrier signal of a predetermined carrier frequency, the carrier wave oscillator coupled to receive the modulation signal from the modulation oscillator and operable, upon receipt thereof, to supply a modulated carrier signal including at least the predetermined frequency;
a plurality of wave emitters adapted to be mounted on the surface, each wave emitter coupled to receive the modulated carrier signal and operable, upon receipt thereof, to emit a wave that includes at least the predetermined frequency;
a plurality of wave receivers, each wave receiver adapted to receive the emitted waves and operable, upon receipt thereof, to supply receiver signals that include at least the predetermined frequency;
a plurality of modulation detectors, each modulation detector coupled to receive receiver signals from one of the wave receivers and operable, upon receipt thereof, to demodulate the modulation signal from the carrier wave and supply the demodulated modulation signal;
a phase detector coupled to receive the demodulated modulation signals from each modulation detector and the modulation signal from the modulation oscillator and operable, upon receipt thereof, to (i) determine phase differences between the modulation signal and each of the demodulated modulation signals and (ii) supply phase difference signals representative thereof, and
a position determination circuit coupled to receive the phase difference signals and operable, upon receipt thereof, to determine the position of the laser welding wand relative to the surface.

13. The system of claim 12, further comprising:
a multiplexer coupled between the carrier wave oscillator and the plurality of wave emitters, the multiplexer configured to selectively supply the modulated carrier signal to each of the wave emitters.

14. The system of claim 12, wherein the position determination circuit is further operable to (i) compare the determined position to one or more predetermined position limits and (ii) supply an interlock signal having a magnitude based on the comparison.

15. The system of claim 14, further comprising:
a laser power circuit coupled to receive the interlock signal and operable, in response thereto, to selectively energize or deenergize a laser.

16. A method of determining a position of a hand-held laser welding wand relative to a surface, comprising the steps of:
emitting a wave from a plurality of positions on the surface, each emitted wave including at least a predetermined frequency;
receiving each of the emitted waves at a plurality of locations on the hand-held laser welding wand;
determining phase shifts between the emitted waves and the received waves at each of the plurality of locations; and
determining the position of the laser welding wand relative to the surface based on the determined phase shifts.

17. The method of claim 16, further comprising:
comparing the determined position to one or more predetermined position limits; and
selectively inhibiting laser emission from a laser based on the comparison.

18. The method of claim 17, wherein the predetermined position limits include user-settable position limits, and wherein the method further comprises:
scanning a predetermined area of the surface to define a boundary; and
storing data representative of the boundary as the user-settable position limits.

19. The method of claim 18, wherein the predetermined position limits further include absolute maximum position limits, and wherein the method further comprises:
inhibiting laser emission from the laser if the determined position exceeds one or more of the absolute maximum position limits; and
inhibiting laser emission from the laser if the determined position is outside of the defined boundary.
